(19) United States
(12) Patent Application Publication
(10) Pub. No.: US 2005/0117689 A1
(43) Pub. Date: Jun. 2, 2005

(54) Reactor cooling system

(75) Inventors: Toshimitsu Usui, Hitachi (JP); Koji Ando, Hitachi (JP); Masayoshi Matsuura, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(73) Assignee: Hitachi, Ltd.

(21) Appl. No.: 10/772,369

(22) Filed: Feb. 6, 2004

Related U.S. Application Data
(62) Division of application No. 10/387,372, filed on Mar. 14, 2003.

(30) Foreign Application Priority Data
Nov. 26, 2001 (JP) 2001-359145

(51) Int. Cl. G21C 9/00

(52) U.S. Cl. 376/282

(57) ABSTRACT

The present invention is characterized by a reactor cooling system, which comprises a lower drywell which is a space for containing a bottom side portion of the reactor pressure vessel, the lower drywell being disposed in a lower portion of the reactor pressure vessel; reactor recirculation pumps for circulating cooling water in the reactor pressure vessel, the reactor recirculation pump being disposed in the bottom side portion of the reactor pressure vessel in such a manner that a side of a motor portion of the reactor recirculation pump is projected into the lower drywell; and heat exchangers disposed in the lower drywell, the cooling water circulated by the reactor recirculation pump passing through the heat exchanger, wherein number of the reactor recirculation pumps is 4 or 6, and the reactor recirculation pumps are arranged with nearly equal angular spacing.

### BACKGROUND OF THE INVENTION

1. Field of the Invention

The present invention relates to a reactor cooling system comprising recirculation internal pumps (internal pumps: hereinafter, referred to as RIPS) for circulating cooling water in a reactor pressure vessel.

2. Prior Art

An RIP system in a conventional advanced boiling water reactor (hereinafter, referred to as ABWR) will be described below, referring to FIG. 9, FIG. 10 and FIG. 11.

FIG. 9 is a plan view showing the arrangement of conventional RIP systems, and FIG. 10 is a detailed plan view showing the arrangement of the conventional RIP systems, and shows the ¼-portion. FIG. 9 and FIG. 10 show the arrangement of the RIP systems in a lower drywell of a reactor containment. FIG. 11 shows the system construction of a conventional power system.

In the conventional ABWR, ten RIP systems are nearly equally spaced in the circumferential direction of the lower portion of the reactor pressure vessel, as shown in FIG. 9. Arc-shaped through-cutouts 19, 20 are formed at two positions in peripheral portions of an upper grid plate 17 and an upper shroud 16 so that the upper grid plate 17 and the upper shroud 16 do not interfere with the RIP 1 when the RIP 1 is withdrawn for maintenance and inspection. The reason why number of the through-cutouts formed is not ten, which is equal to number of the RIPs, is that there are two header pipes 18 having an arc shape in approximately 1/4-circumference for a core injection system which interfere with the withdrawal of the RIP. Therefore, the through-cutouts are formed at the minimal two positions.

During RIP maintenance work, the recirculation internal pump 1 is turned in the circumferential direction in a downcomer region between the reactor pressure vessel 5 and the core shroud from a given installed position of the RIP 1 to one of the two cutout portions 19, 20 through which the RIP 1 is withdrawn. As shown in FIG. 10, each of the RIP systems is constructed by connecting one RIP 1 and one heat exchanger 4 disposed most closely to each other by connecting pipes 9 and 10. The reason why one heat exchanger is combined with one RIP is that in a case where, for example, two RIPS (RIP (A) and RIP (B)) are connected to one heat exchanger, if the RIP (A) stops operation during normal operation, the RIP (B) continues to be operated and the operating RIP (B) can be not sufficiently cooled because part of cooling water passes through the stopping RIP (A). In order to avoid this problem, it is necessary to provide a check valve in the loop. However, provision of the check valve increases the pressure loss in the loop to decrease the flow amount of the cooling water. Therefore, in order to ensure soundness of the component and eliminate an influence of a single-failure, the RIP system has been constructed by combining one heat exchanger with one RIP.

A construction of a conventional RIP power system will be described below, referring to FIG. 11. In a conventional ABWR, the reactor output power is changed by controlling rotating speed of the RIPs 1 contained in the reactor pressure vessel 5 to change the core flow rate. Control of pump rotating speed of the ten RIPs (1a to 1j) is performed using stationary variable frequency power supplies RIP-ASDs (2a to 2j) provided for the individual pumps. Regarding the RIP-ASDs (2a to 2j), the stationary variable frequency power supplies RIP-ASDs (2a, 2b) are connected to a bus line 3a installed in the power station; and the stationary variable frequency power supplies RIP-ASDs (2c to 2e) are connected to a bus line 3b; the stationary variable frequency power supplies RIP-ASDs (2f, 2g) are connected to a bus line 3c; and the stationary variable frequency power supplies RIP-ASDs (2h to 2j) are connected to a bus line 3d.

Electric power generated by a turbine generator is transmitted to the outside of the power station though a circuit breaker 8a, 8b and a power transmission line 6a, 6b. Part of the generated electric power is distributed to the inside of the power station through the bus line 3 and the branched bus lines 3a to 3d. Power supplies for driving the recirculation pumps 1 are three systems of the normal power supply from the bus line 3, a diesel-driven generator 7a and a diesel-driven generator 7b.

### SUMMARY OF THE INVENTION

Although most of conventional nuclear reactors have been large-sized, improvement of middle- and small-sized nuclear reactors is recently studied in addition to the large-sized nuclear reactors. In the middle- and small-sized nuclear reactor, it becomes more difficult to perform maintenance and inspection of RIPs and heat exchangers disposed in a lower drywell because the size of the lower drywell becomes smaller.

Further, it is desirable that a pump runner of the RIP can be withdrawn as easily as possible because maintenance and inspection of the runner is performed by being withdrawn out of the nuclear pressure vessel.

An object of the present invention is to provide a reactor cooling system of which maintenance and inspection can be easily performed by solving the above problems.

The present invention is characterized by a reactor cooling system, which comprises a lower drywell which is a space for containing a bottom side portion of the reactor pressure vessel, the lower drywell being disposed in a lower portion of the reactor pressure vessel; reactor recirculation pumps for circulating cooling water in the reactor pressure vessel, the reactor recirculation pump being disposed in the bottom side portion of the reactor pressure vessel in such a manner that a side of a motor portion of the reactor recirculation pump is projected into the lower drywell; and heat exchangers disposed in the lower drywell, the cooling water circulated by the reactor recirculation pump passing through the heat exchanger, wherein number of the reactor recirculation pumps is 4 or 6, and the reactor recirculation pumps are arranged with nearly equal angular spacing.

Further, the present invention is characterized by a reactor cooling system, which comprises a lower drywell which is a space for containing a bottom side portion of the reactor pressure vessel, the lower drywell being disposed in a lower portion of the reactor pressure vessel; reactor recirculation pumps for circulating cooling water in the reactor pressure vessel, the reactor recirculation pump being disposed in the bottom side portion of the reactor pressure vessel in such a manner that a side of a motor portion of the reactor recirculation pump is projected into the lower drywell; a lower shroud for containing fuel rods therein, the lower shroud being disposed inside the reactor pressure vessel; and an upper shroud mounted on the lower shroud, the upper shroud having an outer diameter lager than an outer diameter of the lower shroud, wherein a runner of each of the reactor recirculation pumps driven by the motor portion is disposed in an inner bottom portion of the reactor pressure vessel and between an inner periphery of the reactor pressure vessel and an outer periphery of the lower shroud, and a through-cutout capable of passing the runner therethrough is formed corresponding to each of the runners at a position just above the runner in an outer peripheral side of the upper shroud.

### BRIEF DESCRIPTION OF DRAWINGS

FIG. 1 is a vertical cross-sectional view of a reactor containment, and shows an embodiment in accordance with the present invention.

FIG. 2 is a cross-sectional view of a transverse section of the central portion of a reactor pressure vessel, and shows an embodiment in accordance with the present invention.

FIG. 3 is a view showing the arrangement of reactor recirculation pumps and a heat exchanger in a reactor containment, and shows an embodiment in accordance with the present invention.

FIG. 4 is a diagram of a power supply system for the reactor recirculation pumps, and shows an embodiment in accordance with the present invention.

FIG. 5 is a vertical cross-sectional view of a reactor pressure vessel, and shows an embodiment in accordance with the present invention.

FIG. 6 is an enlarged view of the portion (A) of FIG. 5, and shows an embodiment in accordance with the present invention.

FIG. 7 is a cross-sectional view of an upper shroud and a lower shroud which shows portions where through-cutouts are formed, and shows an embodiment in accordance with the present invention.

FIG. 8(a) is a view showing an example of a conventional arrangement of reactor recirculation pumps, heat exchangers, secondary cooling water inlet pipes and secondary cooling water outlet pipes, and the conventional arrangement is shown for comparison with an embodiment of the present invention shown in FIG. 8(b).

FIG. 8(b) is a view showing an arrangement of reactor recirculation pumps, heat exchangers, secondary cooling water inlet pipes and secondary cooling water outlet pipes, of an embodiment in accordance with the present invention.

FIG. 9 is a view showing a conventional example, and corresponds to FIG. 2.

FIG. 10 is a view showing a conventional example, and corresponds to FIG. 3.

FIG. 11 is a view showing a conventional example, and corresponds to FIG. 4.

### DESCRIPTION OF THE PREFERRED EMBODIMENTS

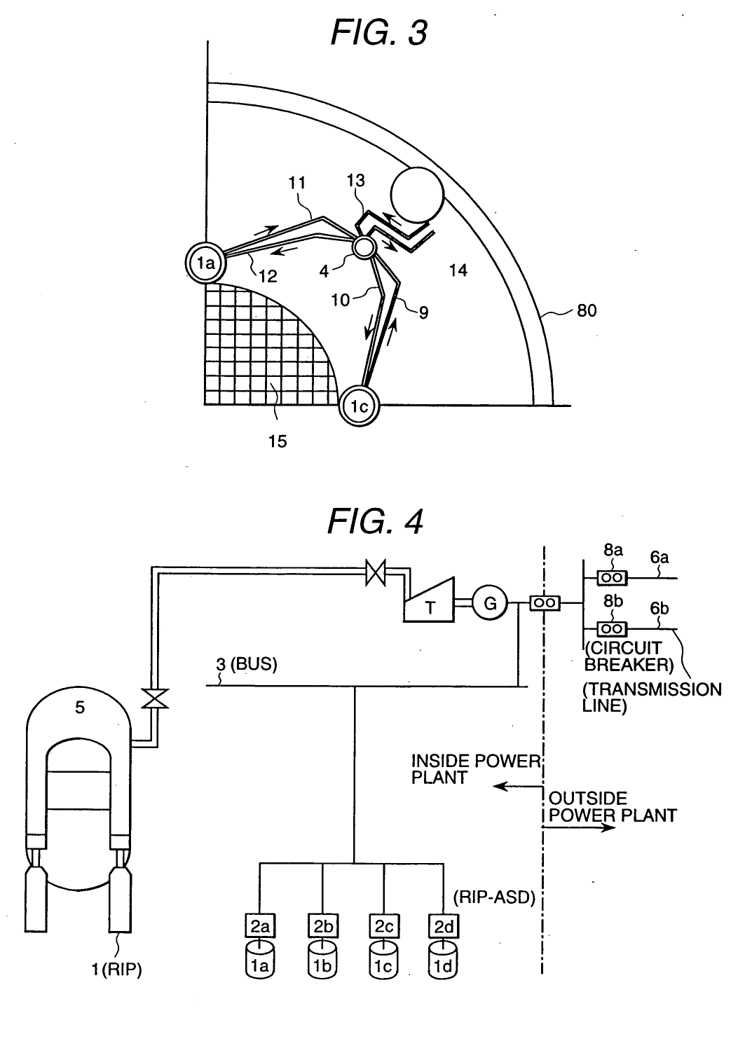

Embodiments in accordance with the present invention will be described below, referring to FIG. 1 to FIG. 8. Repetition of description on things common to the conventional ones will be avoided by attaching common reference characters as far as possible.

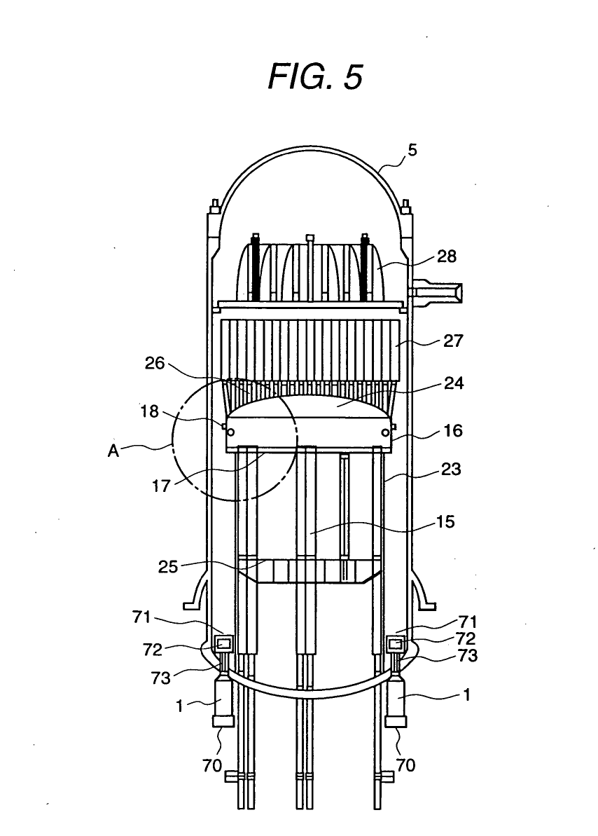

As shown in FIG. 1, FIG. 4 and FIG. 5, four RIPs (reactor recirculation pumps) 1 are arranged in a lower head portion (a bottom portion side) of a reactor pressure vessel (RPV) 5 with 90° spacing in the peripheral direction. Number of the RIPs may be six. Even number, four or six, of the reactor recirculation pumps are arranged in the outer peripheral side of the reactor pressure vessel.

The reactor recirculation pump 1 comprises a motor portion 70 and a pump portion 71, and a runner 72 disposed in the pump portion 71 is detachably supported by a driving shaft 73 extending from the motor portion 70. The motor portion 70 of the reactor recirculation pump 1 is attached to the reactor pressure vessel (RPV) 5 so as to project from the outer side bottom portion of the reactor pressure vessel (RPV) 5, and the pump portion 71 is placed so as positioned inside the reactor pressure vessel (RPV) 5.

The reactor recirculation pumps 1 (RIPs 1) forcedly circulate coolant (liquid such as cooling water or the like) of the reactor inside the reactor pressure vessel (RPV) to promote heat removal and steam generation in the core, and serve the function of controlling reactor output power by increasing and decreasing the core flow rate.

In a case where the RIPs of the conventional ABWR, in which the RIP heat exchangers are connected to the RIPs in a one-to-one relationship, are applied to a middle- and small-reactor, it can be considered from only the viewpoint of geometrical arrangement that the minimum necessary arrangement and number of RIPs is a structure of arranging three RIPs with 120° spacing in the peripheral direction. In the case of three-RIP structure, it is practical from the viewpoint of unitization and operability that three RIP heat exchangers are also installed.

Since the four-RIP structure is employed in the present invention, the system can be simplified by sharing one RIP heat exchanger 4 between the two RIPs though the minimum necessary number of the RIPs is increased by one.

Therein, the sharing of the RIP heat exchanger is on the premise that partial operation of the RIPs will be not performed. This is to be described in detail later.

The lower drywell 81 is arranged in the center of the reactor containment 80. The reactor pressure vessel (RPV) is installed so that the bottom portion side of the reactor pressure vessel (RPV) is placed into a space of the lower drywell. Since the lower drywell 81 is formed large enough for the outer diameter of the reactor pressure vessel 80 and deep enough for the bottom of the reactor pressure vessel (RPV), the lower drywell 81 can contain the reactor recirculation pumps 1, the heat exchangers 4, the secondary cooling water inlet pipes 13 and the secondary cooling water outlet pipes 14.

A space 82 having a small diameter is formed under a central bottom of the lower drywell 81. This space 82 is a room for installing burn-up control rods 83. The space 82 is partitioned from the lower drywell 81 by a mesh-grid bottom plate 84. That is, the floor of the lower dryer 81 is formed by the mesh-grid bottom plate 84.

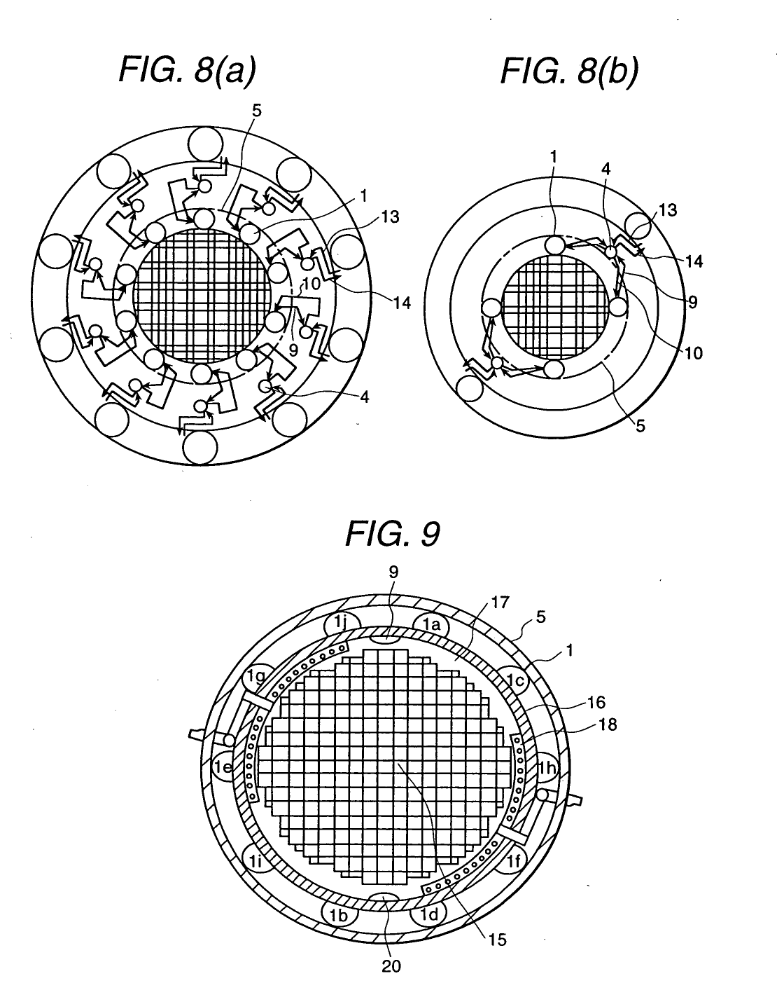

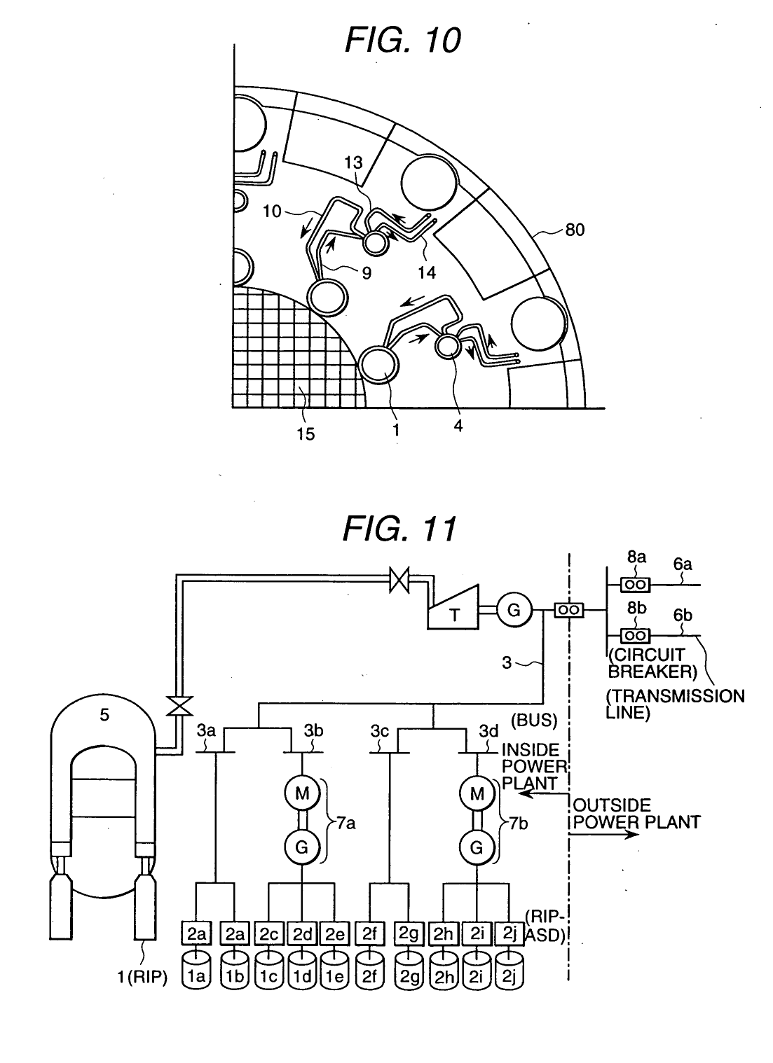

In the lower drywell 81, the reactor recirculation pumps 1, the heat exchangers 4, connecting pipes 9 and 10, the secondary cooling water inlet pipes 13 and the secondary cooling water outlet pipes 14 are arranged as shown in FIGS. 8(a) and 8(b). In the conventional large-sized reactor, these components are intricately arranged, as shown in FIG. 8(a). However, in the middle- and small-sized reactor in accordance with the present invention, these components are arranged apart from one another. The inside of the lower drywell 81 is narrowed by placing these components. However, since the lower drywell 81 in accordance with the present invention is less intricate and has the extra space compared to the conventional lower drywell, maintenance and inspection work of the reactor recirculation pumps 1, the heat exchangers 4, the secondary cooling water inlet pipes 13 and the secondary cooling water outlet pipes 14 can be easily performed inside the lower drywell 81. Since there are radiant rays leaking from the reactor pressure vessel (RPV) inside the lower drywell 81, it is important to shorten the working time by improving workability of the maintenance and inspection work.

One heat exchanger 4 may be provided for one reactor recirculation pump 1. However, by providing one heat exchanger 4 for two reactor recirculation pumps 1, spare area inside the lower drywell 81 is increased to make the inspection work easier.

Further, the nuclear power plant can be substantially simplified because of small number of the reactor recirculation pumps, and because of small numbers of the connecting pipes 9 and 10, the secondary cooling water inlet pipes 13 and the secondary cooling water outlet pipes 14 are also small, and particularly because of only two heat exchangers 4, which can be understood from FIGS. 8(a) and 8(b).

FIG. 4 shows an embodiment of a power supply system for RIP control units in accordance with the present invention.

Pump rotation speeds of the four reactor recirculation pumps 1 (RIPS 1a to 1d) are controlled by the stationary variable frequency power supplies (RIP-ASDS). Partial operation of the reactor recirculation pumps 1 (RIPs) is not performed, and all the RIPs are stopped at once when at least one of the four RIPs stops during normal operation. Since the driving power supply for the RIP needs not to be divided, driving power is supplied to all the four RIPs from one power source of a bus line 3 inside the power station. Therefore, the system can be simplified.

However, employing of the single-train power supply system can be considered possible only in the RIP system that RIP rotation speed can be maintained for a necessary time period or longer by mechanical inertia at an event of loss of power (tripping of the four RIPS) or the like to sufficiently moderate thermal influences on the fuels by relaxing a rapid change in the core flow rate. In a case where thermal influences on the fuels can not be moderated at tripping of the four RIPS, employing of a two-train power supply system and provision of an MG set (diesel-driven generator) are required.

Further, although the present embodiment has the RIP-ASDs 2a to 2d for the individual pumps, the plant can be further simplified by reducing the number of the RIP-ASDs as small as possible because the partial operation of the reactor recirculation pumps 1 is not performed.

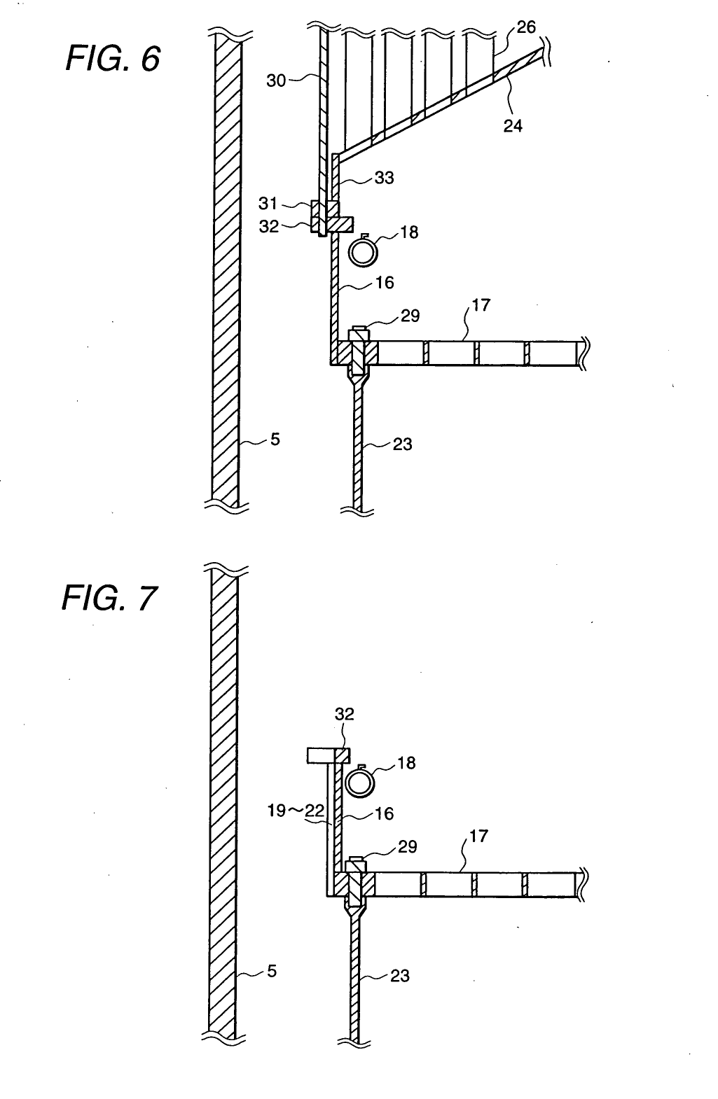

Maintenance and inspection of the runner 72 in the reactor recirculation pump 1 will be described below, referring to FIG. 6 and FIG. 7.

Description will be made including the internal constructions of the reactor pressure vessel (RPV) 5 because the runner 72 is placed inside the reactor pressure vessel (RPV) 5.

The reactor pressure vessel (RPV) 5 is composed of a vertically long cylinder portion, a spherical bottom head and an upper head.

The lower shroud 23 placed in the reactor pressure vessel (RPV) 5 has a cylindrical body portion and is so placed that the body portion becomes concentric with the reactor pressure vessel. The lower end side of the lower shroud 23 is supported by an inner bottom portion of the reactor pressure vessel (RPV) 5. The pump portion 71 and the runner 72 are placed between the outer periphery of the lower shroud 23 and the inner periphery of the reactor pressure vessel (RPV) 5 and near the inner bottom portion of the reactor pressure vessel (RPV) 5. The portion placing the pump portions 71 and the runners 72 is a narrow annular groove vertically extending.

The core support plate 25 is arranged in a sublevel of the lower shroud 23, and the upper grid plate 17 is supported in the upper portion of the lower shroud 23. A region between the core support plate 25 and the upper grid plate 17 mainly corresponds to the core. Fuel rods 15 placed in the region are supported by the core support plate 25 and the upper grid plate 17. The upper grid plate 17 is fixed to the lower shroud 23 by grid attaching bolts 29.

The upper shroud 16 has a cylindrical body portion. The upper grid plate 17 is arranged in the lower end side of the body portion of the upper shroud 16, and an upper shroud fringe portion 32 is arranged in the upper end side of the upper shroud 16. The upper grid plate 17 and the upper shroud fringe portion 32 are fixed to the upper shroud by welding.

The diameter of the outer periphery of the upper shroud is formed larger than that of the outer periphery of the lower shroud. That is, the diameter of the body portion of the upper shroud is formed larger than that of the body portion of the lower shroud. In the outer peripheral side of the upper shroud, through-cutouts 19, 20, 21 and 22 capable of passing the runners 72 therethrough are formed at positions just above the runners 72 so as to correspond to the individual reactor recirculation pumps 1. Since the reactor recirculation pumps 1 are arranged with 90° spacing, the through-cutouts 19, 20, 21 and 22 are also arranged with 90° spacing. Each of the through-cutouts 19, 20, 21 and 22 is vertically formed over the wall of the upper shroud from the upper grid plate 17 to the upper shroud fringe portion 32. Each of the through-cutouts 19, 20, 21 and 22 is arc-shaped so as to match with the shape of the runner 72, but the through-cutout having another shape may be acceptable if the runner 72 can pass through. Although each of the through-cutouts 19, 20, 21 and 22 looks as if it were formed by being cut out from the outer peripheral side, the through-cutout in the body portion of the upper shroud 16 is formed by pressing the appropriate positions of the body portion toward the inner side.

A shroud head 24 is placed on the upper side of the upper shroud. Steam separators 27 are arranged on the shroud head 24 through stand pipes 26. A rim body 33 is provided in the outer peripheral side of the shroud head 24, and a rim body fringe portion 31 is provided in the lower end of the rim head 33. The shroud head 24 is mounted on the upper shroud by putting the rim body fringe portion 31 on the upper shroud fringe portion 32. The shroud head 24 is fixed to the upper shroud by fastening the rim body fringe portion 31 and the upper shroud fringe portion 32 using long shroud head bolts 30. A steam dryer assembly 28 is arranged above the steam separators 27.

The maintenance and inspection work of the runners 72 of the reactor recirculation pumps 1 is performed as follows. Initially, the upper head of the reactor pressure vessel (RPV) 5 is removed. Next, the steam separators 27 are removed after removing the steam dryer assembly. The upper shroud supporting the fuel rods and the core portion of the lower shroud are not removed from and left in the reactor pressure vessel (RPV) 5.

Then a tool for removing the runner is lowered down from the upper side of the reactor pressure vessel (RPV) 5, and the runner is taken off from the pump portion 71 existing in the bottom portion of the narrow annular groove formed between the outer periphery of the lower shroud 23 and the inner periphery of the reactor pressure vessel (RPV) 5 using the tool, and the runner is taken out to the outside through the through-cutout while the runner is being held with the tool, and then the maintenance and inspection work is performed.

The series of jobs relating to taking-out of the runner for maintenance and inspection are difficult to perform, but the runner can be taken out to the outside of the reactor pressure vessel (RPV) 5 by lowering the tool directly downward through the through cutout, and then by pulling the tool directly upward after taking off the runner from the pump portion.

In the past, after lowering down the tool through the through-cutout, the tool is transversely moved along the annular groove up to a desired runner. Then, after taking off the runner using the tool, the tool is returned to the position of the through-cutout again by transversely moving the tool while holding the runner. After that, the runner is drawn out through the through-cutout.

In the present invention, since the runner can be taken out by lowering directly downward through the through-cutout and then by pulling directly upward the tool after taking off the runner, the workability is extremely better compared to the conventional work because there is no need to transversely moving the tool along the annular groove, which is different from the conventional work.

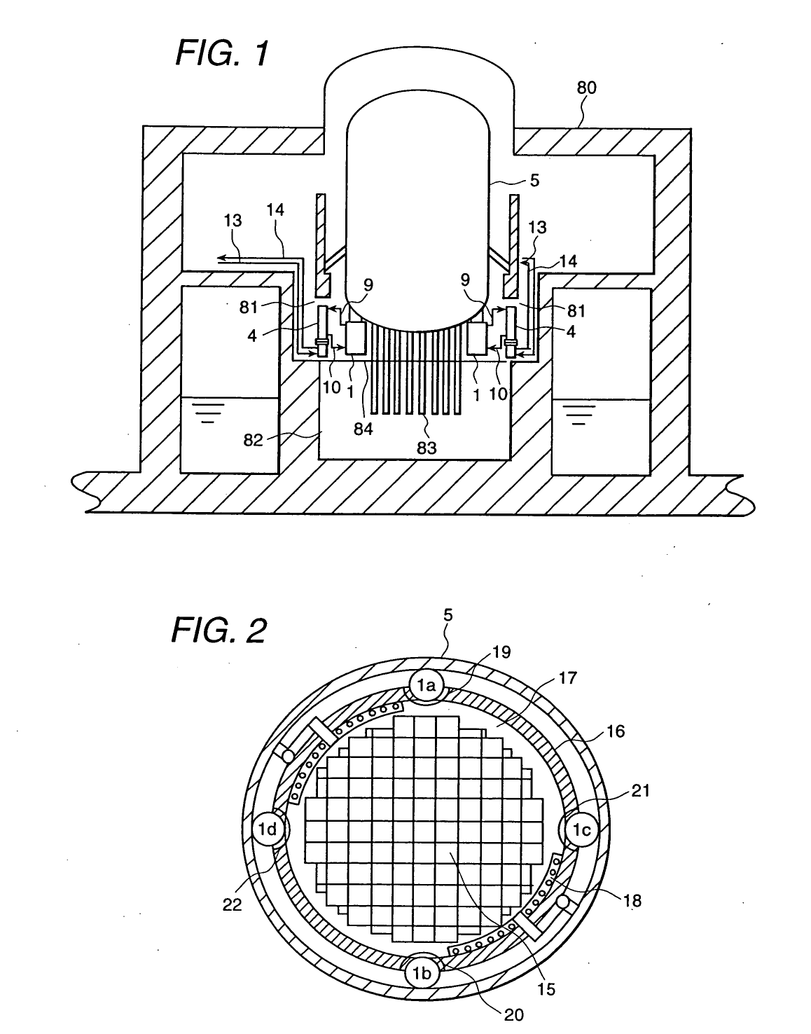

The core injection system header pipe 18 is limited within a range somewhat narrower than 90 degrees, as shown in FIG. 2. The reason why the core injection system header pipe is formed so as to fall within the range smaller than 90 degrees is to avoid that the through-cutout provided in the body portion of the upper shroud 16 interfere with an end portion of the core injection system header pipe 18. The core injection system header pipe 18 is arranged near and along the inner peripheral surface of the body portion of the upper shroud. Since the through-cutouts provided in the body portion of the upper shroud are formed by being pressed toward the inner side, the inner side portion of the through-cutout may hit the core injection system header pipe 18.

The core injection system header pipes 18 are arranged at two positions, but may be arranged at four positions. In a case where the core injection system header pipe 18 is in a range larger than 90 degrees, the four reactor recirculation pumps 1 can not be arranged with equal spacing. In order to uniformly cool the core 15 in the reactor pressure vessel (RPV) 5, it is preferable that the reactor recirculation pumps 1 are arranged with equal spacing.

As having been described above, according to the present invention, it is possible to provide a reactor cooling system of which maintenance and inspection can be easily performed.

1-4. (canceled)

5. A reactor cooling system, which comprises:
a reactor containment for containing a reactor pressure vessel;
a lower drywell which is a space for containing a bottom side portion of said reactor pressure vessel, lower portion of said reactor pressure vessel being disposed in said lower drywell;
reactor recirculation pumps for circulating cooling water in said reactor pressure vessel, each of said reactor recirculation pumps being disposed in the bottom side portion of said reactor pressure vessel in such a manner that motor portion of each of said reactor recirculation pumps is projected into said lower drywell;
a lower shroud for containing fuel rods therein, said lower shroud being disposed inside said reactor pressure vessel; and
an upper shroud mounted on said lower shroud, said upper shroud having an outer diameter larger than an outer diameter of said lower shroud, wherein
runners of said reactor recirculation pumps, each driven by said motor portion are disposed in an inner bottom portion of said reactor pressure vessel and between an inner periphery of said reactor pressure vessel and an outer periphery of said lower shroud, and through-cutouts capable of passing said runners therethrough respectively are formed corresponding to said runners, respectively, at such positions right above said runners in an outer peripheral side of said upper shroud that all said runners align vertically with all said through-cutouts at the same time, respectively.

6. A reactor cooling system according to claim 5, wherein said lower shroud comprises a cylindrical body portion, said upper shroud comprising a cylindrical body portion, said body portion of said upper shroud being formed so as to have a diameter larger than a diameter of said body portion of said lower shroud, said through-cutouts being formed in a periphery of said body portion of said upper shroud.

7. A reactor cooling system according to claim 5, wherein said lower shroud comprises a cylindrical body portion, said upper shroud comprising a cylindrical body portion, said body portion of said upper shroud being formed so as to have a diameter larger than a diameter of said body portion of said lower shroud, a grid plate being disposed in a lower side portion of said body portion of said upper shroud, an upper shroud fringe portion being disposed in an upper side portion of said shroud, said through-cutouts being formed in said body portion of said upper shroud and said grid plate and said upper shroud fringe portion.

8. A reactor cooling system according to claim 5, further comprising:
heat exchangers through which the cooling water circulated by said reactor recirculation pumps flows, said heat exchangers being disposed in said lower drywell; and
even number of said reactor recirculation pumps, said reactor recirculation pumps being arranged with nearly equal angular spacing, and respective two of said recirculation pumps being fluidly connected to each one of said heat exchangers, wherein
each of said heat exchangers is used for two of said reactor recirculation pumps.

9. A reactor cooling system according to claim 5, further comprising a single-train power supply system for driving said reactor recirculation pumps, wherein input power to power supplies for driving said reactor recirculation pumps is supplied from said-single-train power supply system.

10. A reactor cooling system according to claim 5, further comprising reactor recirculation pump control units and a power supply system for said reactor recirculation pump control units constructed so that when at least one of said reactor recirculation pumps stops during normal operation, all the other of said reactor recirculation pumps are stopped.
